(19) United States
(12) Patent Application Publication
(10) Pub. No.: US 2004/0027694 A1
(43) Pub. Date: Feb. 12, 2004

(54) Adjustable segmented dual function mirror with video display

(75) Inventor: William Lin, San Jose, CA (US)

Correspondence Address: C.P. Chang c/o Pacific Law Group LLP, 2 North Second Street, Suite 290, San Jose, CA, 95113, US

(73) Assignee: Mediaview Technologies Corporation, San Jose, CA

(21) Appl. No.: 10/214,013

(22) Filed: Aug. 6, 2002

(51) Int. Cl. G02B 5/08

(52) U.S. Cl. 359/839

(57) ABSTRACT

An Adjustable Segmented Dual Function Mirror with video display (ASDFM) suitable for providing alternatively or simultaneously both a conventional reflected image and a video image under a wide range of ambient lighting condition is disclosed. The ASDFM comprises a two-dimensional connection of traditional mirror segments and dual function mirror segments. Each dual function mirror segment can be rotationally and adjustably connected to the rest of the ASDFM to achieve an optimal visually relevant image-to-ambient contrast for viewing. Alternatively, a position adjustable variable transmissivity screen, a controllable variable transmissivity film or a controllable variable reflectivity film can be included in a dual function mirror segment that is rigidly connected to the rest of the ASDFM for the same purpose. Numerous mechanical, fluid dynamical and electrical implementations are described.

### FIELD OF THE INVENTION

This invention relates generally to dual function mirrors for a variety of use including, but not limited to, a rear view mirror in an automobile, which can function either separately or simultaneously as an ordinary reflective mirror and a video display unit under a variety of direction and intensity of a surrounding ambient lighting condition.

### BACKGROUND OF THE INVENTION

US patent to William Lin (U.S. Pat. No. 5,956,181, issue date: Sep. 21, 1999, hereinafter referred to as “Lin Patent”), disclosed a two way, rear view mirror suitable for providing alternatively or simultaneously both a conventional reflected image and a video image. A preferred embodiment of Lin Patent comprises a flat transparent plate coated with or glued with a reflective film mounted within a casing which provides support for the mirror and a mounting space for at least one video display monitor with a built-in light source mounted in the casing and positioned directly behind the reflective film to receive and display image received from a variety of information sources.

However, in an application environment where there is a wide variety of direction and intensity of a surrounding ambient lighting condition, sometimes the two way, rear view mirror made according to Lin Patent exhibited an insufficient video image contrast for a clear view in the presence of exceptionally high ambient intensity. This problem is especially serious when the direction of the already intense ambient light would cause a specular reflection of the ambient light into the eyes of a user.

It is therefore an object of the present invention to further improve upon the two way, rear view mirror made thereof by providing a general purpose adjustable dual function mirror with video display that can still function under a wide variety of direction and intensity of a surrounding ambient lighting condition.

### SUMMARY

The present invention is directed to an Adjustable Segmented Dual Function Mirror with video display (ASDFM) suitable for providing alternatively or simultaneously both a conventional reflected image and a video image under a wide range of ambient lighting condition.

The first objective of this invention is to provide for an ASDFM that includes both traditional type of reflective mirror segments and dual function type of mirror segments.

The second objective of this invention is to provide for a dual function type of mirror segments that are adjustable so as to be suitable for providing alternatively or simultaneously both a conventional reflected image and a video image under a wide range of ambient lighting conditions.

Other objectives, together with the foregoing are attained in the exercise of the invention in the following description and resulting in the embodiment illustrated in the accompanying drawings.

### BRIEF DESCRIPTION OF DRAWINGS

The current invention will be better understood and the nature of the objectives set forth above will become apparent when consideration is given to the following detailed description of the preferred embodiments. For clarity of explanation, the detailed description further makes reference to the attached drawings herein:

FIG. 1A is a side view of a prior art two way mirror according to Lin Patent with added images, light beams and a user's eye;

FIG. 1B is a graphical illustration of the underlying physics of operation of the two way mirror in FIG. 1A;

FIG. 2A, FIG. 2B and FIG. 2C illustrate an important effect on a visually relevant image-to-ambient contrast from a rotation of the two way mirror and FIG. 2D and FIG. 2E illustrate the same effect as shown in FIG. 2A, FIG. 2B and FIG. 2C except that a nonessential backside casing element as illustrated in FIG. 1A is eliminated therefrom;

FIG. 3A and FIG. 3B illustrate a typical non-uniform distribution of ambient lighting intensity within an auto vehicle;

FIG. 4A, FIG. 4B and FIG. 4C illustrate an embodiment of the present invention ASDFM wherein an end segment of a dual function mirror is rotationally adjustable around a first axis and a second axis within the ASDFM;

FIG. 5A, FIG. 5B and FIG. 5C illustrate another embodiment of the present invention ASDFM wherein a middle segment of a dual function mirror is rotationally adjustable around a second axis within the ASDFM;

FIG. 5D, FIG. 5E and FIG. 5F illustrate a few detailed examples of rotationally adjusting a dual function mirror segment of the present invention ASDFM.

FIG. 6A, FIG. 6B and FIG. 6C illustrate a third embodiment of the present invention ASDFM wherein a stationary dual function mirror end segment includes an added interposed position adjustable variable transmissivity screen;

FIG. 7A and FIG. 7B illustrate a fourth embodiment of the present invention ASDFM wherein a stationary dual function mirror end segment includes an electrically controllable variable transmissivity LCD film; and

FIG. 8A and FIG. 8B illustrate a fifth embodiment of the present invention ASDFM wherein a stationary dual function mirror end segment includes a surface-roughness controllable variable-reflectivity film.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

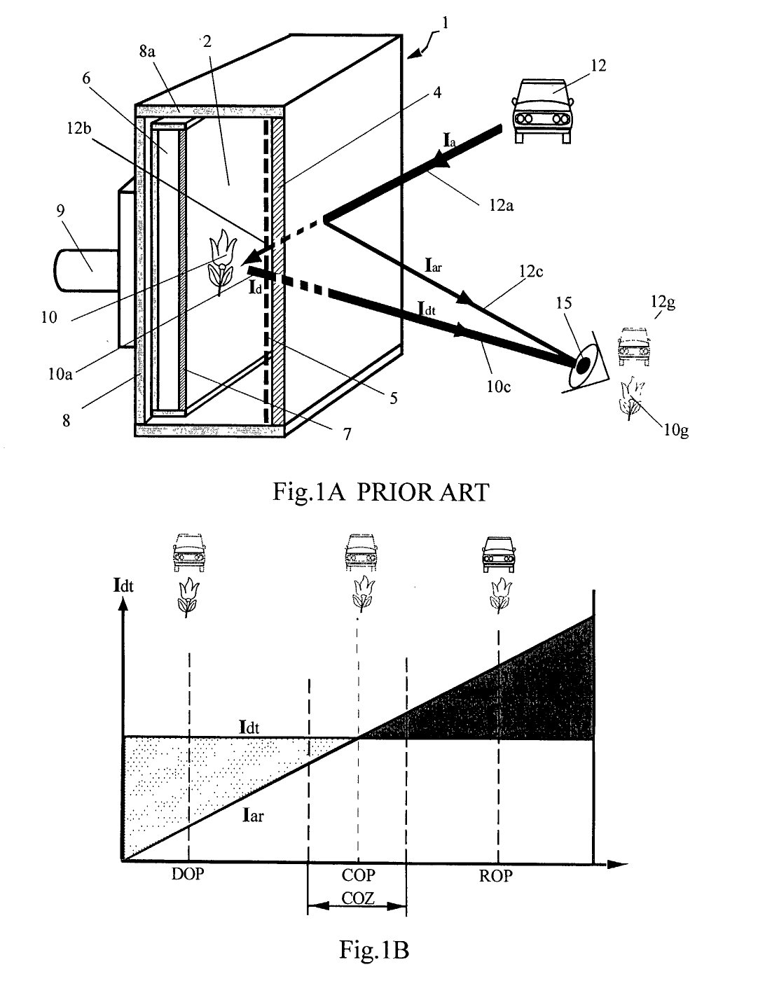

FIG. 1A is a side view of a prior art two-way mirror according to Lin Patent with added images, light beams and a user's eye. A dual function mirror segment 1 is constructed of a flat transparent plate 4, which may be either a glass plate or a plastic plate, on a backside of which is placed a translucent reflective film 5 made by either silver or aluminum. On the back side of the flat transparent plate 4 is mounted a casing 8 made of solid plastic or metal materials, in conjunction with a metal clip 8a, to hold the dual function mirror segment 1 along the circumference of the dual function mirror segment 1 which may be mounted to a surface by a support column 9.

The casing 8 is mounted to the dual function mirror segment 1 in such a way that a space is provided to accommodate a video display device 2 which is mounted in and enclosed entirely inside the casing 8 and placed directly behind the translucent reflective film 5. The video display device 2 has a display screen 7 at its front side for image display and a backside 6 from where a lead wire (not shown) leaves the rear of the video display device 2 through suitable openings on the casing 8 to connect to a source of electrical power and ground. It is noted that the translucent reflective film 5 can be placed in a variety of locations, for example at a front side of the flat transparent plate 4, which may be either a glass or a plastic plate. Alternatively, the translucent reflective film 5 can be placed directly on a front side of the display screen 7 of the video display device 2. Also, the translucent reflective film 5 described above can even be combined with the flat transparent plate 4 to form a tinted glass or tinted plastic plate.

As illustrated, a displayed image 10 is produced on the display screen 7 of the video display device 2, indicated by an auxiliary dashed arrow. A displayed image light beam 10a with a displayed image light intensity Id, emitted from the displayed image 10, goes through the translucent reflective film 5 and the flat transparent plate 4 with partial transmission, and emerges as a displayed image transmitted light beam 10c with a transmitted display image light intensity I_{dt} being sensed by a user's eye 15 with a formation of a displayed image formation in user's eye 10g. Simultaneously, an ambient object 12 emits an ambient object light beam 12a with an ambient object light intensity Iₐ towards the dual function mirror segment 1. The ambient object light beam 12a gets partially reflected, by the multiplayer structure comprising the flat transparent plate 4, the translucent reflective film 5 and the display screen 7, into an ambient object reflected light beam 12c with a reflected ambient object light intensity lar being sensed by a user's eye 15 with a formation of an ambient object image formation in user's eye 12g. At the same time, an ambient object transmitted light beam 12b goes through the afore-mentioned multiplayer structure and impinges upon the display screen 7. While both the displayed image 10 and the ambient object 12 are illustrated herein with a physical object for convenience, it is remarked that in reality either one or both of them can be just a distributed light source with a variety of spectral compositions.

As the user's eye 15 senses both the transmitted display image light intensity I_{dt} and the reflected ambient object light intensity Iₐᵣ, the net image perception of a user of the dual function mirror segment 1 depends upon the relative intensities of the transmitted display image light intensity I_{dt} and the reflected ambient object light intensity Iₐᵣ and this is illustrated in FIG. 1B that is a graphical illustration of the underlying physics of operation of the dual function mirror segment 1.

For convenience, a visually relevant image-to-ambient contrast Cia, is defined in the following way:

Cᵢₐ=I_{dt}/Iₐᵣ (1)

Under a condition of constant transmitted display image light intensity I_{dt}, FIG. 1B is a plot of a linearly increasing range of reflected ambient object light intensity Iₐᵣ. Thus, toward the left side of FIG. 1B where it is marked with a Display Operating Point (DOP) the following condition exists:

I_{dt}>>Iₐᵣ thus Cᵢₐ>>1.

As a result, the net image perception of a user of the dual function mirror segment 1 is dominated by the displayed image formation in the user's eye, illustrated in solid lines, with a weak superposition of the ambient object image formation in the user's eye, illustrated in dashed lines. This is a very desirable condition of the operation of the dual function mirror segment 1. However, toward the right side of FIG. 1B where it is marked with a Reflective Operating Point (ROP) the following condition exists:

I_{dt}<<Iₐᵣ thus Cᵢₐ<<1.

As a result, the net image perception of a user of the dual function mirror segment 1 is dominated by the ambient object image formation in the user's eye, illustrated in solid lines, with a weak superposition of the displayed image formation in the user's eye, illustrated in dashed lines. This is clearly a very undesirable condition of the operation of the dual function mirror segment 1. At the middle of FIG. 1B, where it is marked with a Cross Over Point (COP), the following condition exists:

I_{dt}=Iₐᵣ thus Cᵢₐ=1.

As a result, the net image perception of a user of the dual function mirror segment 1 is a blurred superposition of both the displayed image formation and the ambient object image formation in the user's eye, both illustrated in dashed lines. This is also a very undesirable condition of the operation of the dual function mirror segment 1. For those skilled in the art, it should become clear now that, within the middle zone of FIG. 1B where it is marked with a Cross Over Zone (COZ) the following condition exists:

I_{dt}˜Iₐᵣ thus Cᵢₐ˜1

and this is also an undesirable condition of the operation of the dual function mirror segment 1. Therefore, the present invention is directed to an ASDFM suitable for providing alternatively or simultaneously both a conventional reflected image and a video image under a wide range of ambient lighting condition while, with a variety of embodiments to be presently illustrated, satisfies the following condition:

Cᵢₐ>>1

by either increasing I_{dt} or decreasing Iₐᵣ or performing both actions when necessary. It is remarked that, in practice for most average users, a Cᵢₐ>=1.5 is found to be satisfactory.

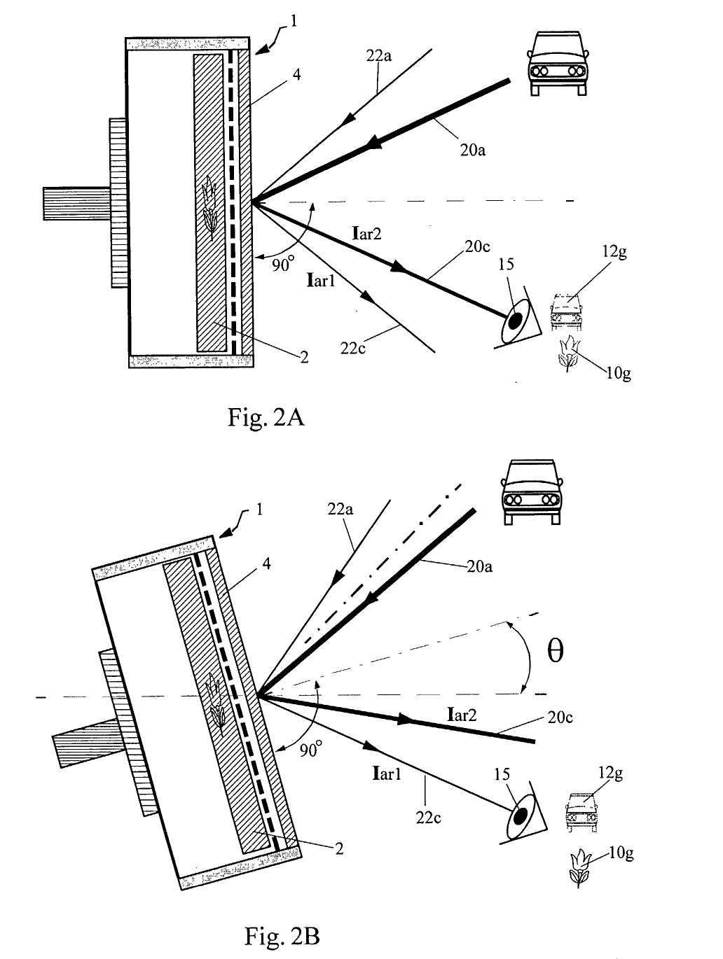

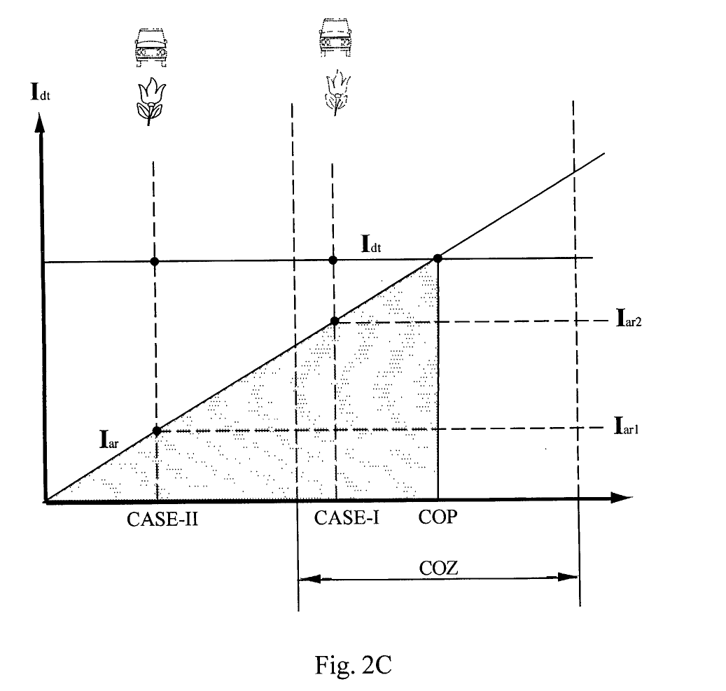

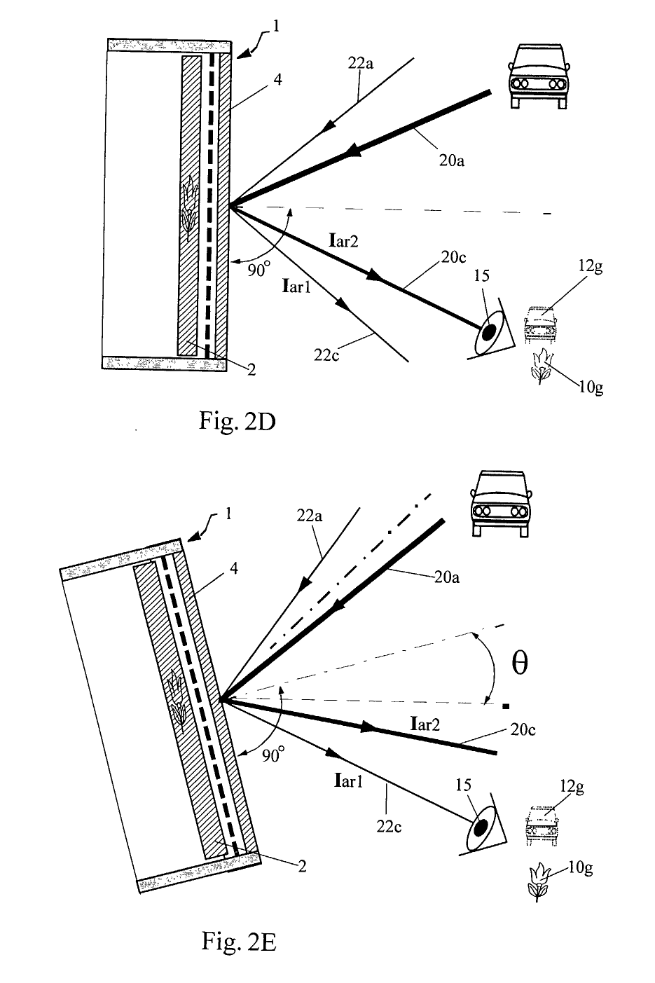

FIG. 2A, FIG. 2B and FIG. 2C show a side view of a two-way mirror, according to Lin Patent as illustrated in FIG. 1A, wherein an important effect of rotation of the dual function mirror segment 1 on the visually relevant image-to-ambient contrast, Cᵢₐ, according to one embodiment of the present invention is discussed. In FIG. 2A, (referred to herein as CASE-I), the flat transparent plate 4 of a dual function mirror segment 1 is oriented in a vertical plane. The ambient lighting condition, among other things, comprises a strong ambient object light beam 20a and a weak ambient object light beam 22a, both are signified with their respective thickness of light beams. The same convention will be followed throughout the rest of the specification to signify the relative intensity of a light beam. Correspondingly, a strong ambient object reflected light beam 20c with a strong reflected ambient object light intensity Iₐᵣ₂ hits the user's eye 15 while a weak ambient object reflected light beam 22c with a weak reflected ambient object light intensity Iₐᵣ₁ misses the user's eye 15. For clarity of illustration, the transmitted display image light intensity I_{dt} is omitted from FIG. 2A and FIG. 2B. Given the various light intensities as stated, the corresponding operating point, CASE-I, is illustrated in FIG. 2C. As CASE-I falls within the COZ, this is an undesirable condition of the operation of the dual function mirror segment 1 and is graphically illustrated with a dashed displayed image formation in user's eye 10g and a dashed ambient object image formation in user's eye 12g.

In FIG. 2B, (referred to herein as CASE-II), the flat transparent plate 4 of a dual function mirror segment 1 is rotated from the vertical plane by an angle θ. As a result, the strong ambient object reflected light beam 20c with a strong reflected ambient object light intensity Iₐᵣ₂ misses the user's eye 15 while the weak ambient object reflected light beam 22c with a weak reflected ambient object light intensity Iₐᵣ₁ hits the user's eye 15. Given the various light intensities as stated here, the corresponding operating point, CASE-II, is also illustrated in FIG. 2C. As CASE-II now falls outside the COZ with I_{dt}>>Iₐᵣ, this means Cᵢₐ>>1 and CASE-II has become a desirable condition of the operation of the dual function mirror segment 1, which is graphically illustrated with a solid displayed image formation in user's eye 10g and a dashed ambient object image formation in user's eye 12g. It is important to remark that, while the angle of rotation θ does also affect the light intensity I_{dt} of the transmitted display image under a typical application environment where the video display device 2 is capable of providing a wide viewing angle coupled with a fairly limited angle of rotation, say less than 45 degrees, the corresponding variation of I_{dt} is comparatively small compared to that of the Iₐᵣ. Therefore, by properly adjusting the angular orientation of the dual function mirror segment 1 with respect to a user, an optimal Cᵢₐ can be achieved for viewing under a variety of direction and intensity of a surrounding ambient lighting condition.

FIG. 2D and FIG. 2E illustrate the same effect as just illustrated in FIG. 2A, FIG. 2B and FIG. 2C on the visually relevant image-to-ambient contrast Cᵢₐ from a rotation of the dual function mirror segment 1 except that a nonessential backside casing element (i.e., the numeral 8 of FIG. 1) of the two-way mirror, according to Lin Patent as illustrated in FIG. 1A, is eliminated therefrom. For those skilled in the art, it should be clear that while the backside casing element can be optionally included in the dual function mirror segment 1 for increased structural rigidity or cosmetic considerations, the presence of the backside casing element is really not essential for the just illustrated effect whereby an optimal Cᵢₐ can be achieved for viewing under a variety of direction and intensity of a surrounding ambient lighting condition.

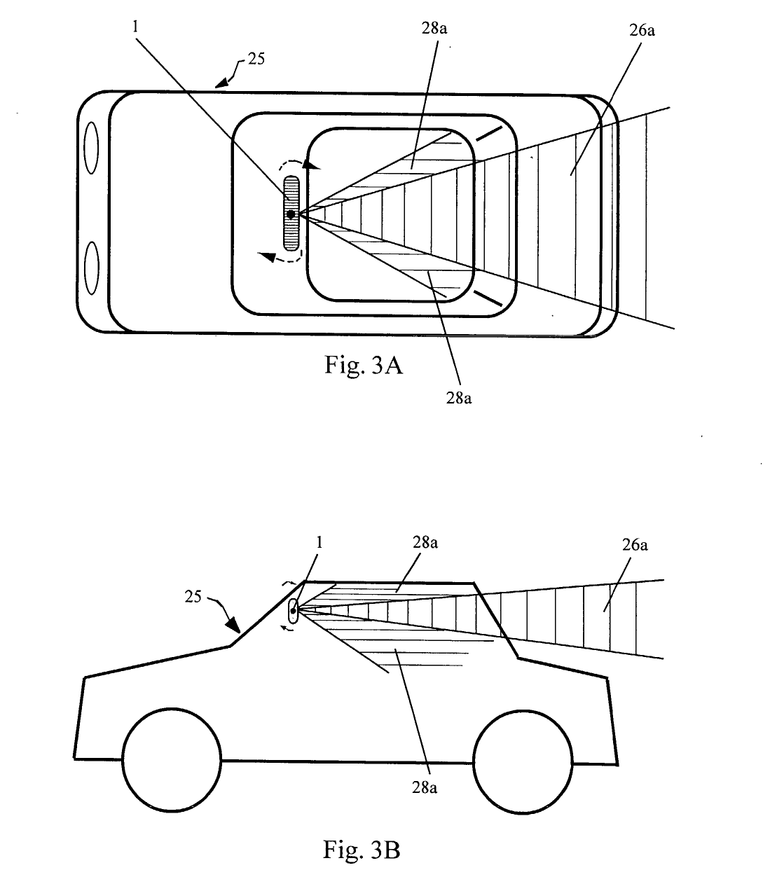

FIG. 3A and FIG. 3B illustrate a variety of direction and intensity of a surrounding ambient lighting condition within an automobile 25 for the application of the dual function mirror segment 1 with the technique of angular adjustment as just described. In FIG. 3A, due to the conventional frame structure of the automobile 25, a strong ambient light zone 26a surrounded by two weak ambient light zones 28a are typically formed within a horizontal plane intersecting the dual function mirror segment 1. Thus, the dual function mirror segment 1 needs to be angularly adjusted around a vertical axis as illustrated. In FIG. 3B, due to the conventional roof and frame structure of the automobile 25, a strong ambient light zone 26a surrounded by two weak ambient light zones 28a are typically formed within a vertical plane intersecting the dual function mirror segment 1. Thus, the dual function mirror segment 1 needs to be angularly adjusted around a horizontal axis as illustrated.

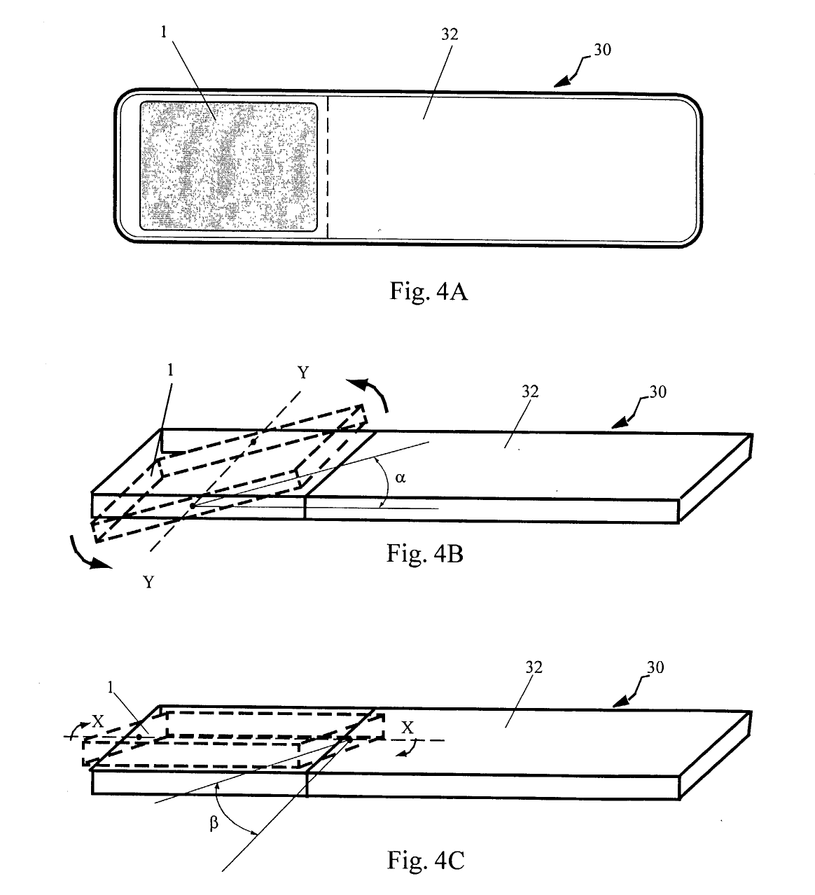

Accordingly, FIG. 4A, FIG. 4B and FIG. 4C illustrate an embodiment of the present invention ASDFM 30. In FIG. 4A the ASDFM 30 is shown to comprise a dual function mirror segment 1 at the left end that is mechanically connected to a traditional mirror segment 32. In FIG. 4B the dual function mirror segment 1 is connected to the rest of the ASDFM 30 through a first axis Y-Y for the rotational adjustment, at an angle α, of the dual function mirror segment 1. In FIG. 4C the dual function mirror segment 1 is connected to the rest of the ASDFM 30 through a second axis X-X for the rotational adjustment, at an angle β, of the dual function mirror segment 1.

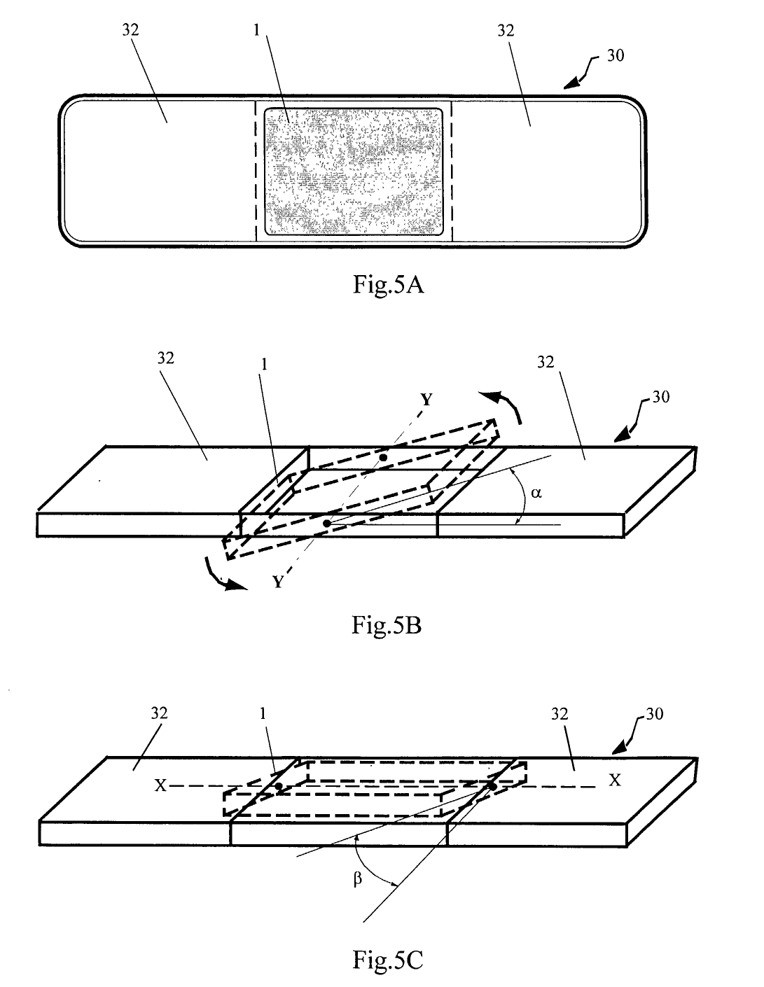

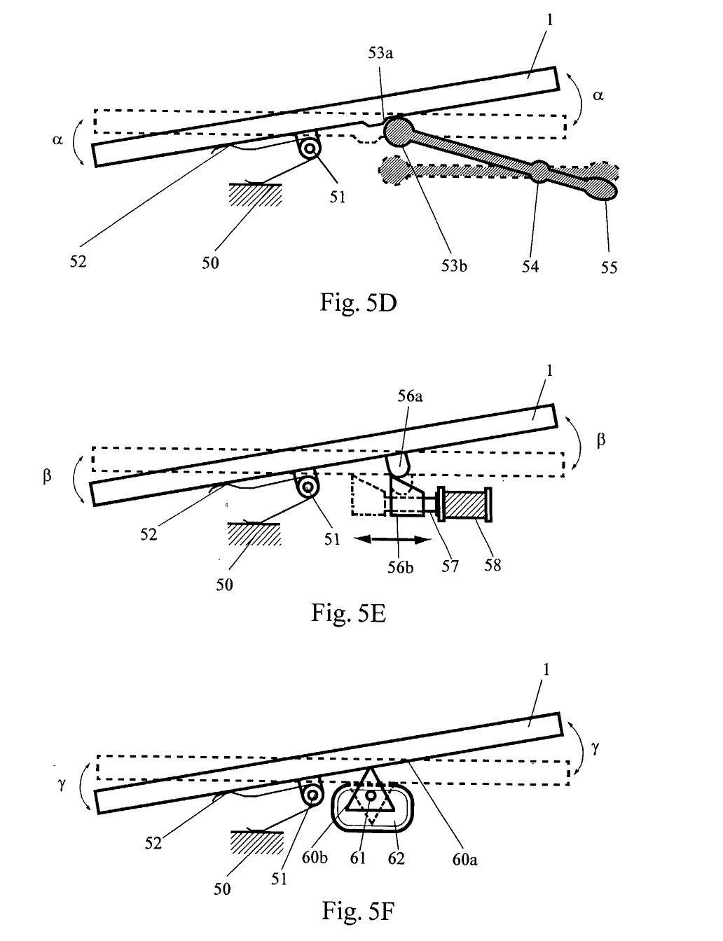

FIG. 5A, FIG. 5B and FIG. 5C illustrate another embodiment of the present invention ASDFM 30. In FIG. 5A the ASDFM 30 is shown to comprise a dual function mirror segment 1 located in the middle that is mechanically connected to two traditional mirror segments 32. In FIG. 5B the dual function mirror segment 1 is connected to the rest of the ASDFM 30 through a first axis Y-Y for the rotational adjustment, at an angle α, of the dual function mirror segment 1. In FIG. 5C the dual function mirror segment 1 is connected to the rest of the ASDFM 30 through a second axis X-X for the rotational adjustment, at an angle β, of the dual function mirror segment 1. By now it should become clear that, within the ASDFM 30, a variety of combinations of the number and location of dual function mirror segments 1, the number and location of traditional mirror segments 32 and the orientation of rotational axis for each of the dual function mirror segments 1 can be implemented using the same principle of operation as described. In fact, a simultaneous multiple axis rotation can even be implemented for the dual function mirror segment 1 using, for example, a gimbal-mount structure.

Referring now to FIG. 5D, FIG. 5E and FIG. 5F, a few detailed examples of rotationally adjusting the dual function mirror segment 1 of the present invention ASDFM are illustrated. The rest of the details of the present invention ASDFM are not shown here to avoid any unnecessary obscuring details. In FIG. 5D, the dual function mirror segment 1 is pivotally mounted onto a fixed frame surface 50 through a combination of a pivot axis 51 and a torsion spring 52. The dual function mirror segment 1 has an integrated engaging tab 53a that slidably engages an engaging curved cam 53b of a handle bar 55 that is manually and rotationally operated around a rotation axis 54 to effect an angle of rotation α. FIG. 5E is similar to FIG. 5D except that an engaging tab member 56a of the dual function mirror segment 1 works in sliding contact with an engaging sloped cam 56b that is in turn rigidly connected to a reciprocating plunger 57 of an electromagnetic relay 58 electrically activated to effect an angle of rotation P. FIG. 5F is also similar to FIG. 5D except that a back surface 60a of the dual function mirror segment 1 works in sliding contact with a trianguler cam 60b that is in turn rigidly connected to a rotation axis 61 driven by a motor 62 electrically controlled to effect an angle of rotation γ. Additionally, although not graphically shown here to avoid unnecessary details, there are numerous mechanical, fluid dynamical and electrical ways to rotationally adjust the dual function mirror segment 1 of the present invention ASDFM. For example, a pneumatically controlled cam, a linear-to-rotation linkage driven by an electromechanical relay and a computer-controlled stepper motor can all be employed to effect the desired rotational adjustment.

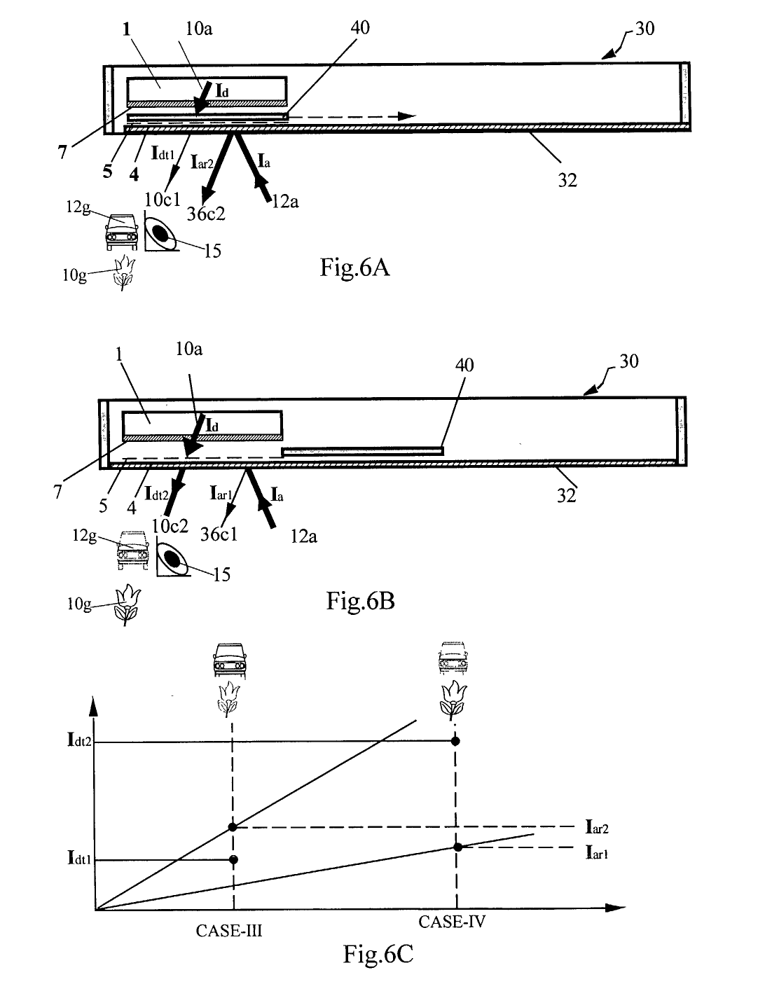

FIG. 6A, FIG. 6B and FIG. 6C illustrate a third embodiment of the present invention ASDFM 30. In FIG. 6A, (referred to herein as CASE-III), the ASDFM 30 is shown to comprise a dual function mirror segment 1 at the left end that is mechanically connected to a traditional mirror segment 32. While there is no possibility of relative mechanical motion between the dual function mirror segment 1 and the rest of the ASDFM 30, an added position adjustable variable transmissivity screen 40 is interposed between the translucent reflective film 5 and the display screen 7. With the adjustable variable transmissivity screen 40 placed directly in front of the display screen 7, the position adjustable variable transmissivity screen 40 acts both as a layer to increase the composite reflectivity of the dual function mirror segment 1 for an ambient object light beam 12a with an ambient object light intensity Iₐ and as a layer to decrease the composite transmissivity for a displayed image light beam 10a with a displayed image light intensity I_{d}. Thus, the correspondingly reflected and transmitted lights from the dual function mirror segment 1 are a strong ambient object reflected light beam 36c2 with a strong reflected ambient object light intensity Iₐᵣ₂ and a weak displayed image transmitted light beam 10c with a weak transmitted display image light intensity I_{dt1}. Given the various light intensities as stated, the corresponding operating point, CASE-III, is illustrated in FIG. 6C. As I_{dt1}<Iₐᵣ₂ thus Cᵢₐ<1, this is an undesirable condition of the operation of the ASDFM 30 that is graphically illustrated with a dashed displayed image formation in user's eye 10g and a solid ambient object image formation in user's eye 12g. In FIG. 6B, (referred to herein as CASE-IV), the adjustable variable transmissivity screen 40 is moved away from the front of the display screen 7 thus decreasing the composite reflectivity of the dual function mirror segment 1 for an ambient object light beam 12a with an ambient object light intensity Iₐ while increasing the composite transmissivity for a displayed image light beam 10a with a displayed image light intensity d. Thus, the correspondingly reflected and transmitted lights from the dual function mirror segment 1 become a weak ambient object reflected light beam 36c1 with a weak reflected ambient object light intensity Iₐᵣ₁ and a strong displayed image transmitted light beam 10c2 with a strong transmitted display image light intensity I_{dt2}.

Referring back to FIG. 6C, the corresponding operating point, CASE-IV, is also illustrated. As I_{dt2}>>Iₐᵣ₁ thus Cᵢₐ>>1, this has now become a desirable condition of the operation of the ASDFM 30 and it is graphically illustrated with a solid displayed image formation in user's eye 10g and a dashed ambient object image formation in user's eye 12g. Therefore, by properly adjusting the position of an added interposed adjustable variable transmissivity screen 40 inside a dual function mirror segment of the ASDFM 30, an optimal Cᵢₐ can be achieved for viewing under a variety of direction and intensity of a surrounding ambient lighting condition. As a variation, the position adjustable variable transmissivity screen 40 can instead be made of a number of adjacent sections each with a successively different light transmissivity followed by a corresponding section-by-section movement to effect an adjustment of Cᵢₐ with a finer resolution. Furthermore, although not shown here to avoid unnecessary obscuring details, there are numerous mechanical, fluid dynamical and electrical ways to implement the desired linear movement of the position adjustable variable transmissivity screen 40. For example, a manually operated mechanical lever coupled with a multiple position detent, a pneumatically driven piston with an automatic spring return to a normal position, an electromechanical relay and a computer-controlled linear motor can all be employed to effect the linear movement.

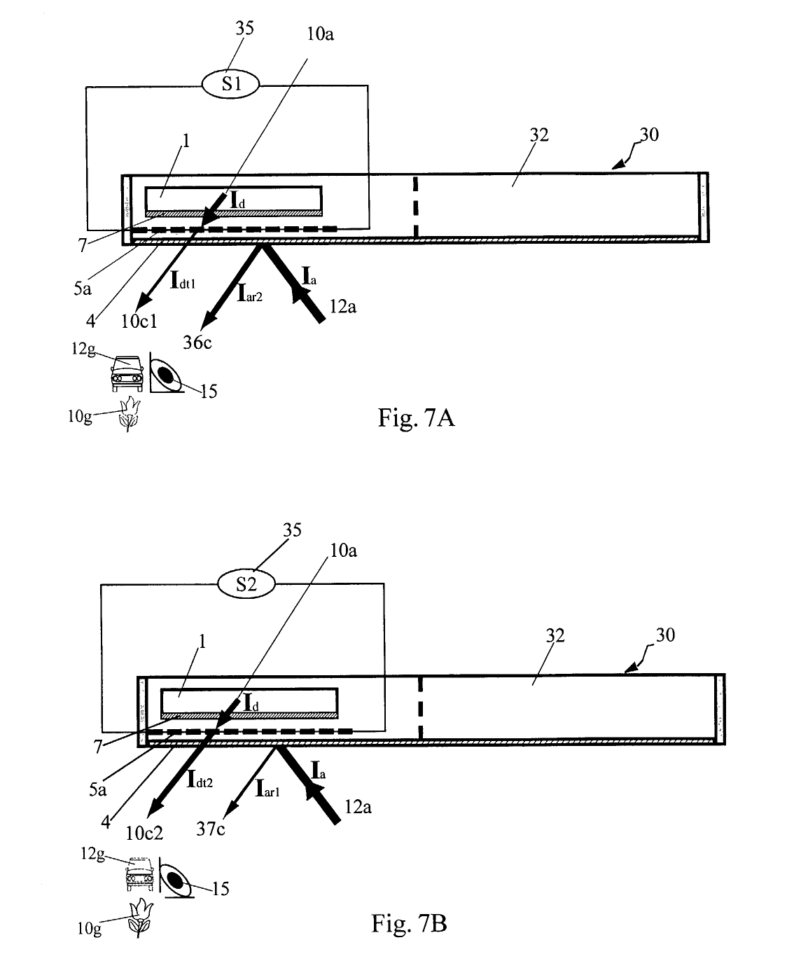

FIG. 7A and FIG. 7B illustrate a fourth embodiment of the present invention ASDFM 30. In FIG. 7A, (referred to herein as CASE-V), the ASDFM 30 is shown to comprise a dual function mirror segment 1 at the left end that is mechanically connected to a traditional mirror segment 32. While there is no relative mechanical motion between the dual function mirror segment 1 and the rest of the ASDFM 30, a controllable variable transmissivity LCD (Liquid Crystal Display) film 5a, electrically driven by an external modulation signal source 35 set at signal level S1, is placed upon the flat transparent plate 4. The controllable variable transmissivity LCD film 5a, comprising a two-dimensional matrix of electrically connected LCD pixels, exhibits a variable light transmissivity that is a function of the signal level of the modulation signal source 35. For the purpose of a simple illustration of the present invention, assuming that:

(1) at signal level S1, the controllable variable transmissivity LCD film 5a exhibits a low transmissivity and

(2) at signal level S2, the controllable variable transmissivity LCD film 5a exhibits a high transmissivity.

Notice that, accompanying a low transmissivity, the controllable variable transmissivity LCD film 5a naturally exhibits a high reflectivity and vice versa. It follows that, in FIG. 7A (CASE-V) wherein the signal level of the modulation signal source 35 is S1, a weak displayed image transmitted light beam 10c1 with a weak transmitted display image light intensity Idt1 is accompanied by a strong ambient object reflected light beam 36c with a strong reflected ambient object light intensity Iar2, an undesirable operating condition, with Cᵢₐ<1, of the ASDFM 30 is created. However, in FIG. 7B (CASE-VI) wherein the signal level of the modulation signal source 35 is switched to S2, a strong displayed image transmitted light beam 10c2 with a strong transmitted display image light intensity Idt2 is now accompanied by a weak ambient object reflected light beam 37c with a weak reflected ambient object light intensity Iar1, a desirable operating condition, with Cia>>1, of the ASDFM 30 is achieved. Therefore, by properly controlling the transmissivity of a controllable variable transmissivity film inside a dual function mirror segment of the ASDFM 30, an optimal Cia can be achieved for viewing under a variety of direction and intensity of a surrounding ambient lighting condition. Notice that the controllable variable transmissivity LCD film 5a can be equivalently implemented with a variety of alternative means whereby a variable transmissivity is produced by a corresponding adjustment of a signal level of the external modulation signal source 35. For example, an electrically controlled light gate or grating should both work well.

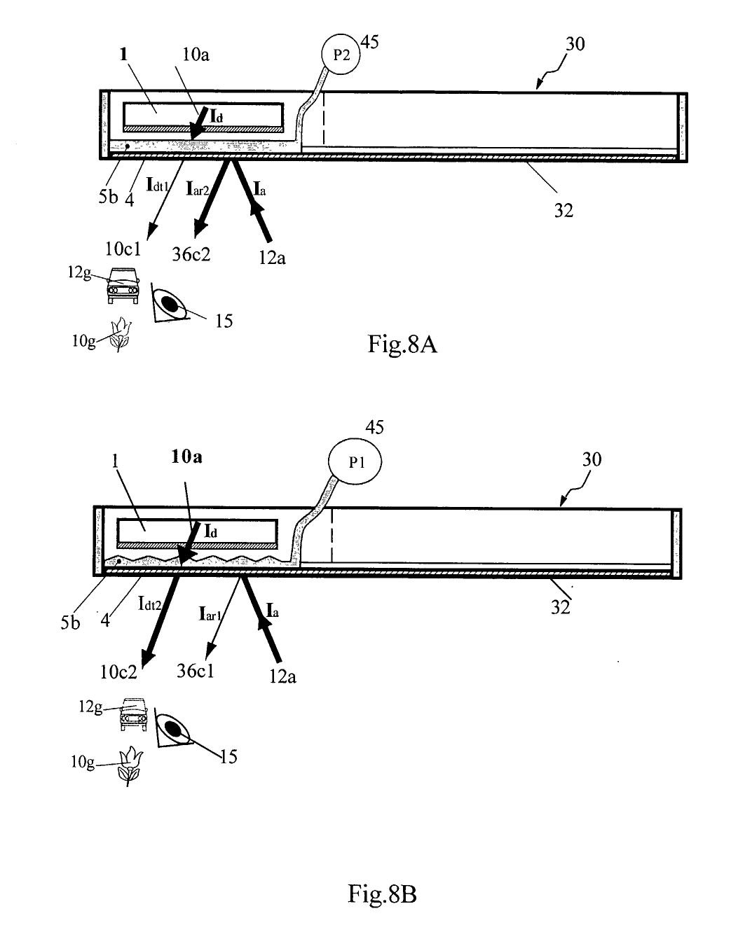

FIG. 8A and FIG. 8B illustrate a fifth embodiment of the present invention ASDFM 30. In FIG. 8A the ASDFM 30 is shown to comprise a dual function mirror segment 1 at the left end that is mechanically connected to a traditional mirror segment 32. While there is no relative mechanical motion between the dual function mirror segment 1 and the rest of the ASDFM 30, a surface-roughness controllable variable-reflectivity film 5b, pressurized by an external controllable pressure source 45, is placed upon the flat transparent plate 4. The surface-roughness controllable variable-reflectivity film 5b, made of a hollow elastomeric film pouch with an integral surface texture that diminishes, with a resulting increase of its reflectivity, with an increased internal air pressure exerted by the controllable pressure source 45. For the purpose of a simple illustration of the present invention, assuming that:

(1) under pressure P₂, the surface-roughness controllable variable-reflectivity film 5b exhibits a high reflectivity and

(2) under pressure P₁, the surface-roughness controllable variable-reflectivity film 5b exhibits a low reflectivity.

Notice that, accompanying a high reflectivity, the surface-roughness controllable variable-reflectivity film 5b naturally exhibits a low transmissivity and vice versa. It follows that, in FIG. 8A wherein the pressure of the controllable pressure source 45 is p₂, a weak displayed image transmitted light beam 10c1 with a weak transmitted display image light intensity I_{dt1} is accompanied by a strong ambient object reflected light beam 36c with a strong reflected ambient object light intensity Iₐᵣ₂, an undesirable operating condition, with Cᵢₐ<1, of the ASDFM 30 is created. However, in FIG. 8B wherein the pressure of the controllable pressure source 45 is reduced to p₁, a strong displayed image transmitted light beam 10c2 with a strong transmitted display image light intensity I_{dt2} is now accompanied by a weak ambient object reflected light beam 37c with a weak reflected ambient object light intensity Iₐᵣ₁, a desirable operating condition, with Cᵢₐ>>1, of the ASDFM 30 is achieved. Therefore, by properly controlling the reflectivity of a surface-roughness controllable variable-reflectivity film inside a dual function mirror segment of the ASDFM 30, an optimal Cᵢₐ can be achieved for viewing under a variety of direction and intensity of a surrounding ambient lighting condition. Notice that there are, other than through the control of surface-roughness as illustrated, many alternative ways to achieve a film with variable reflectivity. For example, a surface-curvature controllable variable-reflectivity film can be made of a thin transparent metallic film pouch wherein one pouch surface would form a slight bulge under an internal pressure. Another surface-curvature controllable variable-reflectivity film can be made of a thin transparent metallic film pouch wherein one pouch surface would cave in slightly under a partial internal vacuum. A third example is a surface-tilt controllable variable-reflectivity film made of a thin transparent metallic film pouch wherein one pouch surface has a gradient wall thickness so that it would undergo a slight tilt under an internal pressure. However, accompanying these alternative ways of implementation, there are associated directional change of the reflected light as well which mechanism nevertheless functions effectively to control the Cᵢₐ as was already explained under FIG. 2A, FIG. 2B and FIG. 2C. Furthermore, although not shown here to avoid unnecessary obscuring details, there are numerous mechanical, fluid dynamical and electrical ways to implement the controllable pressure source 45. For example, a lever operated pneumatic piston coupled with a multiple position detent, a pneumatically driven piston with an automatic spring return to a normal position and a computer-controlled air pump are all candidates for consideration.

As illustrated and described with numerous preferred embodiments, an ASDFM made of a two-dimensional mechanical matrix connection of a number of traditional mirror segments and at least one dual function mirror segments is disclosed that is suitable for providing alternatively or simultaneously both a conventional reflected image and a video image with an optimal visually relevant image-to-ambient contrast Cᵢₐ under a wide range of ambient lighting condition for viewing. However, for those skilled in this field, the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

I claim:

1. An Adjustable Segmented Dual Function Mirror with video display (ASDFM) suitable for providing alternatively or simultaneously both a conventional reflected image and a video image under a wide range of ambient light condition, said ASDFM comprises a two-dimensional matrix connection of a number of traditional mirror segments and at least one dual function mirror segments wherein each of said dual function mirror segments being mechanically connected to the rest of said ASDFM through a rotationally adjustable means, each said dual function mirror segment further comprising:
(a) a flat transparent plate;
(b) a translucent reflective film being placed upon said flat transparent plate;
(c) an optional casing being mounted to a backside of said flat transparent plate to enclose said dual function mirror segment; and
(d) a video display device having a built-in light source and being mounted within said optional casing and positioned directly behind said dual function mirror segment to receive and display images received from a variety of information sources
whereby
(e) each of said number of traditional mirror segments functions as an ordinary reflective mirror;
(f) each of said dual function mirror segments functions as an ordinary reflective mirror when said video display device is deactivated to turn off the built-in light source;
(g) each said dual function mirror segment functions as an image display when said video display device is activated to turn on the built-in light source producing a visually relevant image-to-ambient contrast Cᵢₐ, defined as the ratio between a fraction of a transmitted display image light intensity from each said dual function mirror segment, Idt, and a reflected ambient object light intensity from each said dual function mirror segment, Iar, and
(h) an angular orientation, with respect to a user of the ASDFM, of each said dual function mirror segment, regardless of the variation of direction and intensity of a surrounding ambient light, being correspondingly adjusted through said rotationally adjustable means to achieve an optimal Cᵢₐ for viewing.

2. The ASDFM as in claim 1 wherein said translucent reflective film is placed upon a backside of said flat transparent plate.

3. The ASDFM as in claim 1 wherein said translucent reflective film is placed upon a front side of said flat transparent plate.

4. The ASDFM as in claim 1 wherein said flat transparent plate can be either a glass plate or a plastic plate.

5. The ASDFM as in claim 1 wherein said translucent reflective film is combined with said flat transparent plate to form a tinted glass or plastic plate.

6. The ASDFM as in claim 1 wherein said information sources consist of a plurality of input/output devices selected from the group of television, satellite transmission including global positioning system, video cassette recorder, video camera, computer, wireless network, and audio devices.

7. An Adjustable Segmented Dual Function Mirror with video display (ASDFM) suitable for providing alternatively or simultaneously both a conventional reflected image and a video image under a wide range of ambient light condition, said ASDFM comprises a two-dimensional mechanical matrix connection of a number of traditional mirror segments and at least one dual function mirror segments, each said dual function mirror segment further comprising:
(a) a flat transparent plate;
(b) a translucent reflective film being placed upon said flat transparent plate;
(c) a optional casing being mounted to a backside of said flat transparent plate to enclose said dual function mirror segment;
(d) a video display device having a built-in light source and being mounted within said optional casing and positioned directly behind said dual function mirror segment to receive and display images received from a variety of information sources; and
(e) a variable transmissivity means being movably interposed between said flat transparent plate and said video display device
whereby
(f) each of said number of traditional mirror segments functions as an ordinary reflective mirror;
(g) each of said dual function mirror segments functions as an ordinary reflective mirror when said video display device is deactivated to turn off the built-in light source;
(h) each said dual function mirror segment functions as an image display when said video display device is activated to turn on the built-in light source producing a visually relevant image-to-ambient contrast Cᵢₐ; and
(i) said variable transmissivity means, regardless of the variation of direction and intensity of a surrounding ambient light, being correspondingly adjusted lineally with respect to the rest of said each dual function mirror segment to achieve an optimal Cᵢₐ for viewing.

8. The ASDFM as in claim 7 wherein said translucent reflective film is placed upon a backside of said flat transparent plate.

9. The ASDFM as in claim 7 wherein said translucent reflective film is placed upon a front side of said flat transparent plate.

10. The ASDFM as in claim 7 wherein said flat transparent plate can be either a glass plate or a plastic plate.

11. The ASDFM as in claim 7 wherein said translucent reflective film is combined with said flat transparent plate to form a tinted glass or plastic plate.

12. The ASDFM as in claim 7 wherein said information sources consist of a plurality of input/output devices selected from the group of television, satellite transmission including global positioning system, video cassette recorder, video camera, computer, wireless network, and audio devices.

13. The ASDFM as in claim 7 wherein said variable transmissivity means is a variable transmissivity screen.

14. The ASDFM as in claim 13 wherein said variable transmissivity screen is made of a number of adjacent sections each with a successively different light transmissivity.

15. An Adjustable Segmented Dual Function Mirror with video display (ASDFM) suitable for providing alternatively or simultaneously both a conventional reflected image and a video image under a wide range of ambient light condition, said ASDFM comprises a two-dimensional mechanical matrix connection of a number of traditional mirror segments and at least one dual function mirror segments, each said dual function mirror segment further comprising:
(a) a flat transparent plate;
(b) a controllable variable transmissivity film means being placed upon said flat transparent plate;
(c) an optional casing being mounted to a backside of said flat transparent plate to enclose said dual function mirror segment; and
(d) a video display device having a built-in light source and being mounted within said optional casing and positioned directly behind said dual function mirror segment to receive and display images received from a variety of information sources
whereby
(e) each of said number of traditional mirror segments functions as an ordinary reflective mirror;
(f) each of said dual function mirror segments functions as an ordinary reflective mirror when said video display device is deactivated to turn off the built-in light source;
(g) each said dual function mirror segment functions as an image display when said video display device is activated to turn on the built-in light source producing a visually relevant image-to-ambient contrast Cia; and
(h) said controllable variable transmissivity film means, regardless of the variation of direction and intensity of a surrounding ambient light, being correspondingly adjusted to achieve an optimal Cia for viewing.

16. The ASDFM as in claim 15 wherein said controllable variable transmissivity film means is placed upon a backside of said flat transparent plate.

17. The ASDFM as in claim 15 wherein said controllable variable transmissivity film means is placed upon a front side of said flat transparent plate.

18. The ASDFM as in claim 15 wherein said flat transparent plate can be either a glass plate or a plastic, plate.

19. The ASDFM as in claim 15 wherein said translucent reflective film is combined with said flat transparent plate to form a tinted glass or plastic plate.

20. The ASDFM as in claim 15 wherein said information sources consist of a plurality of input/output devices selected from the group of television, satellite transmission including global positioning system, video cassette recorder, video camera, computer, wireless network, and audio devices.

21. The ASDFM as in claim 15 wherein said controllable variable transmissivity film means is a liquid crystal display film, a light gate or grating.

22. The ASDFM as in claim 15 wherein said controllable variable transmissivity film means is further provided by an external modulation signal source.

23. An Adjustable Segmented Dual Function Mirror with video display (ASDFM) suitable for providing alternatively or simultaneously both a conventional reflected image and a video image under a wide range of ambient light condition, said ASDFM comprises a two-dimensional mechanical matrix connection of a number of traditional mirror segments and at least one dual function mirror segments, each said dual function mirror segment further comprising:
(a) a flat transparent plate;
(b) a controllable variable reflectivity film means being placed upon said flat transparent plate;
(c) an optional casing being mounted to a backside of said flat transparent plate to enclose said dual function mirror segment; and
(d) a video display device having a built-in light source and being mounted within said optional casing and positioned directly behind said dual function mirror segment to receive and display images received from a variety of information sources
whereby
(e) each of said number of traditional mirror segments functions as an ordinary reflective mirror;
(f) each of said dual function mirror segments functions as an ordinary reflective mirror when said video display device is deactivated to turn off the built-in light source;
(g) each said dual function mirror segment functions as an image display when said video display device is activated to turn on the built-in light source producing a visually relevant image-to-ambient contrast Cia; and
(h) said controllable variable reflectivity film means, regardless of the variation of direction and intensity of a surrounding ambient light, being correspondingly adjusted to achieve an optimal Cia for viewing.

24. The ASDFM as in claim 23 wherein said controllable variable reflectivity film means is placed upon a backside of said flat transparent plate.

25. The ASDFM as in claim 23 wherein said controllable variable reflectivity film means is placed upon a front side of said flat transparent plate.

26. The ASDFM as in claim 23 wherein said flat transparent plate can be either a glass plate or a plastic plate.

27. The ASDFM as in claim 23 wherein said translucent reflective film is combined with said flat transparent plate to form a tinted glass or plastic plate.

28. The ASDFM as in claim 23 wherein said information sources consist of a plurality of input/output devices selected from the group of television, satellite transmission including global positioning system, video cassette recorder, video camera, computer, wireless network, and audio devices.

29. The ASDFM as in claim 23 wherein said controllable variable reflectivity film means is further provided with an external controllable pressure source for providing pressure to said controllable variable reflectivity film means.

30. The ASDFM as in claim 29 wherein said controllable variable reflectivity film means is a surface-roughness controllable variable-reflectivity film.

31. The ASDFM as in claim 30 wherein said surface-roughness controllable variable reflectivity film is made of a hollow elastomeric film pouch with an integral surface texture that diminishes with an increased internal air pressure exerted by the controllable pressure source.

32. The ASDFM as in claim 29 wherein said controllable variable reflectivity film means is a surface-curvature controllable variable-reflectivity film.

33. The ASDFM as in claim 32 wherein said surface-curvature controllable variable-reflectivity film is made of a thin transparent metallic film pouch wherein one pouch surface forms a slight bulge under an internal pressure.

34. The ASDFM as in claim 29 wherein said controllable variable reflectivity film means is a surface-tilt controllable variable-reflectivity film.

35. The ASDFM as in claim 34 wherein said surface-tilt controllable variable-reflectivity film is made of a thin transparent metallic film pouch wherein one pouch surface has a gradient wall thickness to undergo a slight tilt under an internal pressure.
